(19) United States
(12) Patent Application Publication
(10) Pub. No.: US 2014/0226711 A1
(43) Pub. Date: Aug. 14, 2014

(54) System and method for self-adaptive streaming of multimedia content

(71) Applicant: HCL Technologies Limited, Chennai (IN)

(72) Inventors: Kumaralingam Ramamoorthy, Chennai (IN); Vengadassalabady Ramanouudjam, Chennai (IN); Rahul Ganapathy Subramaniam, Chennai (IN); Joy Esther Samuel, Chennai (IN)

(21) Appl. No.: 13/922,194

(22) Filed: Jun. 19, 2013

(30) Foreign Application Priority Data
Feb. 13, 2013 (IN) 619/CHE/2013

(51) Int. Cl. H04N 7/26

(52) U.S. Cl. CPC H04N 19/00472
USPC 375/240.02

(57) ABSTRACT

The embodiment provides a method for transmitting optimal video over a network channel. The method includes coding a video into a plurality of frames, estimating bandwidth associated with the network channel, and determining whether the estimated bandwidth associated with the network channel reaches a bandwidth threshold. Further, the method includes transcoding the video in response to determining that the estimated bandwidth associated with the network channel reaches the bandwidth threshold and transmitting the transcoded video over the network channel.

PRIORITY DETAILS

The present application claims priority from Indian Application Number 619/CHE/2013, filed on 13 Feb. 2013, the disclosure of which is hereby incorporated by reference herein.

### TECHNICAL FIELD

The embodiments herein relate to self-adaptive multimedia systems, and more particularly, to a mechanism for dynamically determining multimedia transmission based on bandwidth of a network channel.

### BACKGROUND OF EMBODIMENT

The increasing accessibility to the Internet has fueled a corresponding increase in the accessibility of multimedia content. Many different devices are used by users to watch various forms of multimedia content, such as movie trailers, news clips, sporting highlights, video songs, and the like. The user experience in accessing the various forms of multimedia content is highly dependent on bandwidth capacity of the user network Internet connection. Thus, streaming the various forms of multimedia content on the different devices involves significant challenges.

Different methods and systems are proposed to manage, control, and adjust the multimedia content transmission over communication networks. On demand to stream a single video, the conventional systems and methods includes creating and storing a video with different formats, such as different bit rate, frame rate, frame size, or even compression standard, in a server. Depending on the network channel bandwidth associated with the device used by the user, different videos are streamed. Further, mobility of the devices may include rapid changes in the network connectivity, availability, link quality, service capability, and bandwidth management. While navigating from a high bandwidth location to a low bandwidth location, the server may suddenly start streaming a different video.

Though the conventional systems and methods are effective to a degree in managing, controlling, and adjusting the multimedia content transmission over the communication networks but, include both advantages and disadvantages in terms of performance, network bandwidth, storage, video quality, streaming, smoothness, cost, service optimization, and user experience.

### SUMMARY OF THE EMBODIMENT

Accordingly the embodiment provides a method for transmitting optimal video over a network channel. The method includes coding a video into a plurality of frames, estimating bandwidth associated with the network channel, and determining whether the estimated bandwidth associated with the network channel reaches a bandwidth threshold. Further, the method includes transcoding the video in response to determining that the estimated bandwidth associated with the network channel reaches the bandwidth threshold and transmitting the transcoded video over the network channel.

In an embodiment, the transcoded video is in accordance with the estimated bandwidth associated with the network channel. Furthermore, the method includes clearing coding parameters associated with the plurality of frames and generating transcoding parameters to transcode the video in response to determining that the estimated bandwidth associated with the network channel reaches the bandwidth threshold. In an embodiment, the transcoding parameter is in accordance with the estimated bandwidth associated with the network channel.

Furthermore, the method includes using the transcoding parameters to transcode the plurality of frames, creating video packets using the plurality of transcoded frames, and transmitting the packets over the network channel. Furthermore, the method includes frequently monitoring the bandwidth associated with the network channel and transcoding the video based on the monitoring result.

Accordingly the embodiment provides a system for transmitting optimal video over a network channel. The system includes a server configured to code a video into a plurality of frames, estimate bandwidths associated with the network channel, and determine whether the estimated bandwidth associated with the network channel reaches a bandwidth threshold. Further, the server is configured to transcode the video in response to determining that the estimated bandwidth associated with the network channel reaches the bandwidth threshold and transmit the transcoded video over the network channel.

In an embodiment, the transcoded video is in accordance with the estimated bandwidth associated with the network channel. Furthermore, the server is configured to clear coding parameters associated with the plurality of frames and generate transcoding parameters to transcode the video in response to determining that the estimated bandwidth associated with the network channel reaches the bandwidth threshold.

Furthermore, the server is configured to use the transcoding parameters to transcode the plurality of frames, create video packets using the plurality of transcoded frames, and transmit the packets over the network channel. Furthermore, the server is configured to frequently monitor the bandwidth associated with the network channel and transcode the video based on the monitoring result.

These and other aspects of the embodiments herein will be better understood when considered in conjunction with the following description and the accompanying drawings. It should be understood, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

The embodiments herein will be better understood from the following detailed description with reference to the drawings, in which:

FIG. 1 is a high level block diagram illustrates generally, among other things, a system in which the present embodiment is embodied, according to the embodiments disclosed herein;

FIG. 2 is a block diagram illustrates generally, various modules of the system as described in the FIG. 1, according to embodiments described herein;

FIG. 3 is a sequence diagram illustrating operations performed by the system as described in the FIG. 1, according to the embodiments disclosed herein;

FIG. 4A illustrates generally an exemplary video stream with varied bitrates, according to embodiments described herein;

FIG. 4B illustrates generally an exemplary impact of bandwidth on the video bitrates as described in the FIG. 4A, according to embodiments described herein;

FIG. 5 is a flowchart illustrating a method for transmitting optimal video over a network channel, according to the embodiments disclosed herein; and

FIG. 6 illustrates a computing environment implementing the method and system as disclosed in the embodiments herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for transmitting optimal video over a network channel. A server can be configured to stream live and/or stored video on a client device. The server retrieves requested video from storage and decodes the video into a plurality of frames. A network bandwidth data associated with the network channel used by the client can be estimated. The server can be configured to determine whether the estimated bandwidth associated with the network channel used by the client reaches a bandwidth threshold. In response to determining that the estimated bandwidth associated with the network channel reaches the bandwidth threshold, the server can be configured to generate transcoding parameters to transcode the video and provide optimal video to the client. The transcoding parameters described herein can be in accordance with the estimated bandwidth associated with the network channel used by the client. The coding parameters present in cache can be cleared and the new transcoding parameters can be initialized to transmit optimal video over the network channel. Further, the server can be configured to use the transcoding parameters to transcode the plurality of frames in accordance with the estimated bandwidth associated with the network channel. The server can then create packets using the plurality of transcoded frames and transmit the packets over the network channel.

The proposed system and method is simple, robust, dynamic, inexpensive, and reliable for transmitting optimal video in accordance with the bandwidth associated with the network channels used by the client. Unlike conventional systems and methods, the present embodiment maintains only a single video and dynamically transcode the video in accordance with the bandwidth associated with the network channels. As only a single video is present, the system and method can be used to significantly reduce the overall system storage space and streams optimal video over the network channels with a reasonable system cost. The system and method can be used to provide seamlessly smooth video streaming over the network channels, particularly for the mobile client moving from a high-bandwidth network to a low-bandwidth network and vice versa. Further, the system and method can be used in the context of a generic point-to-point connection between two video clients (e.g., video call) including the two-way multimedia transmission, where changes in the bandwidth of the network channel would produce an impact on both ends of the connection. Furthermore, the proposed system and method can be implemented on the existing infrastructure and may not require extensive set-up or instrumentation.

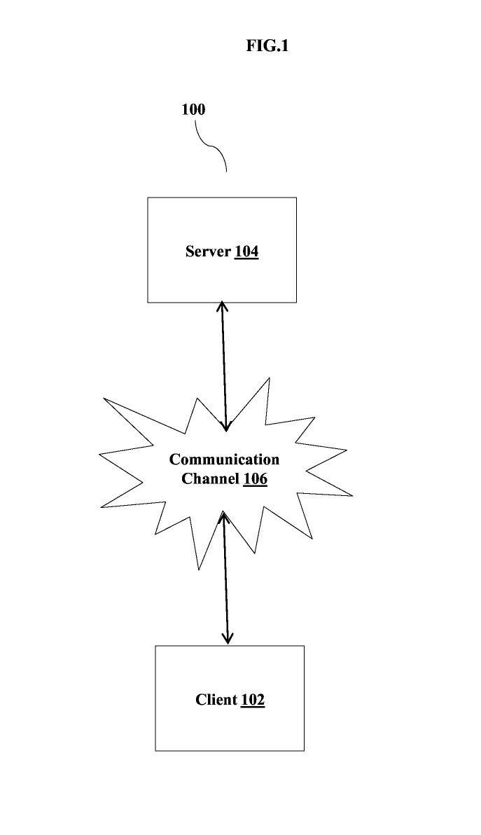

FIG. 1 is a high level block diagram illustrates generally, among other things, a system 100 in which the present embodiment is embodied, according to the embodiments disclosed herein. The system 100 can include a video client 102 and a video server 104 communicating over a network channel 106.

The network channel 106 described herein can include for example, but not limited to, wireless communication network, wire line communication network, cellular network, global system for mobile communication, local area network, wide area network, public network such as the Internet, private network, personal area network, combination thereof, and the like. Further, the system 100 can include application to any type of network channels including those that utilize the Internet Protocol (IP) such as the Internet or any other TCP/IP based network.

In an embodiment, the video client 102 described herein can be any recipient configured to receive the video content over the network channel. The video client 102 can include for example, but not limited to, portable electronic device, desktop computer, laptop computer, tablet, smart phone, personal digital assistance, communicator, online player, native application, standalone application, multimedia player, or any other device or application capable of receiving and playing the video content. The video client 102 can view the video content using high-bandwidth network channel, low-bandwidth network channel, or a combination thereof. In an embodiment, the video client 102 can be a mobile video client moving from the high-bandwidth network channel to the low-bandwidth network channel and vice versa. Further, the available bandwidth of the network channel 106 can vary with time and location irrespective of the video client 102 mobility.

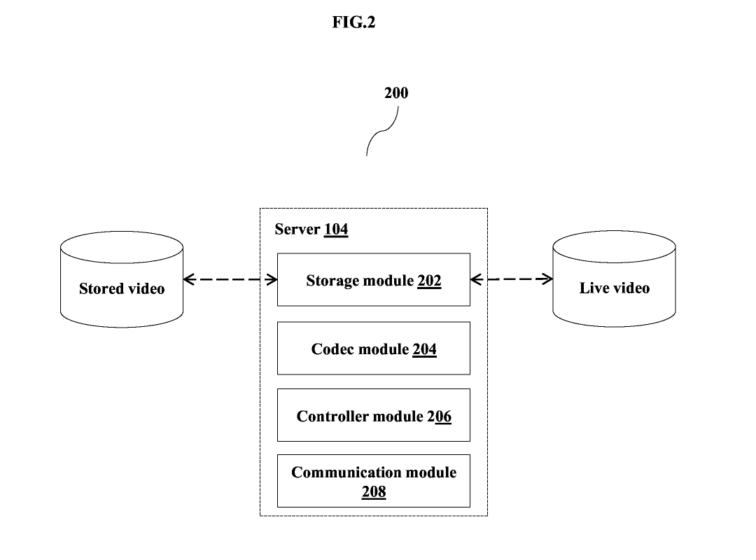

In an embodiment, the video server 104 described herein can be any collection of one or more sources that operates as a source of multimedia content. The server 104 can be configured to stream the video content on the video client 102 using the network channel 106. The server 104 can be configured to determine the bandwidth associated with the network channel 106 used by the video client 102 and accordingly transfer the optimal video over the network channel 106. Further, the detailed operations performed by the system 100 are described in conjunction with FIGS. 2 through 5.

Thought, the FIG. 1 shows only one video server and video client but, in real-time there can be plurality of video clients communicating with the one or more video servers over the network channels. Further, it is understood that another exemplary embodiment is not limited thereto. Furthermore, the present embodiment can also be used in the context of a generic point-to-point connection between two video clients (e.g., video call or conference video call), including the two-way multimedia transmission, where each client could functionally operate as video content provider (or video server) and/or video client. In this scenario, changes in the bandwidth of the network channel would produce an impact on both the ends.

FIG. 2 is a block diagram illustrates generally, various modules of the system 100 as described in the FIG. 1, according to embodiments described herein. The server 104 can be configured to include a storage module 202, a codec module 204, a controller module 206, and a communication module 208.

In an embodiment, the storage module 202 can be configured to store the video content. The video content can be stored on the same computer as the video server 104 or on multiple platforms. The storage module 202 can be configured to interact or communicate with internal and external databases or storage sources to provide the stored or live video contents over the network channel 106. Further, the storage module 202 can be configured to include instructions and other data required to perform coding (such as encoding/compressing and decoding/decompressing) and transcoding (such as re-encoding/re-compressing or re-decoding/re-decompressing) the video content.

In an embodiment, the codec module 204 can be configured to code (such as compress, decompress, encode, or decode) and transcode (such as such as re-encoding/re-compressing or re-decoding/re-decompressing) the video streams that are transmitted over the network channel 106. In an embodiment, the term “code or coding” refers to a process/component or a program module for compressing, decompressing, encoding, and decoding the live or stored video contents. The coded video can be in any suitable format such as for example, but not limited to, audio video interleaved (AVI) format, 3GP, moving picture experts group (MPEG), windows media video (WMV), flash video (FLV), and the like. In an embodiment, the term “transcode or transcoding” refers to the process/component or the program module for converting a previously compressed, decompressed, encoded, or decoded video content into another one with different or same format, such as different bit rate, frame rate, frame size, and/or even compression standard. The codec module 204 can be configured to code or transcode the video content into a plurality of frames. Further, the system 100 can be configured to use any coding/transcoding technique known in the art such as for example, but not limited to, with the motion pictures expert group (MPEG)-1, MPEG-2, MPEG-4, H.264, lossless codec, and the like.

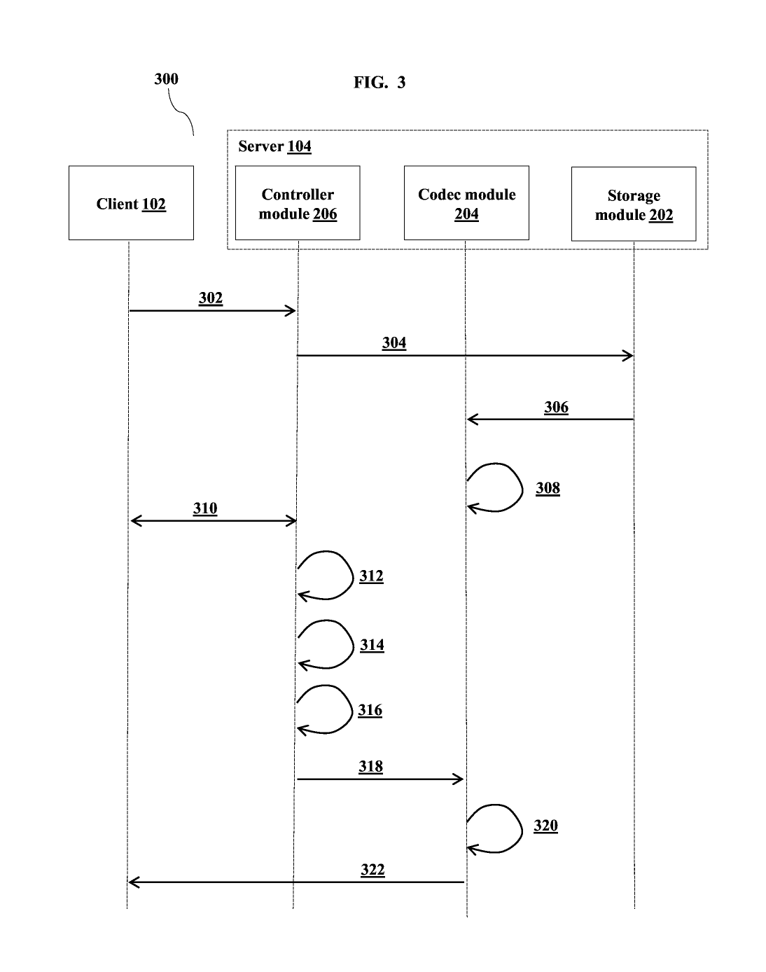

In an embodiment, the controller module 206 described herein can be configured to estimate the bandwidth associated with the network channel 106 used by the video client 102. The controller module 206 can be configured to store a bandwidth threshold to determine the need of changing the video bit rate, such as to provide optimal video to the video client 102. For example, in transmitting a video bit stream over a heterogeneous network channels, the connection from the video server to the video client may be established through links of different bandwidth characteristics and capacities. Any changes in the network channel bandwidth can affect the performance, reliability, smoothness, and quality of the video bit stream transmitted over the network channel. The controller module 206 can be configured to frequently monitor the bandwidth associated with the network channels 106 used by the video client 102 and compare the estimated/monitored bandwidth against the bandwidth threshold. In an embodiment, the controller module 206 can be configured to transcode the video content in response to determining that the estimated bandwidth associated with the network channel 106 used by the video client 102 reaches the bandwidth threshold. The bandwidth required by the video bit rate (coded into the plurality of frames) can be adjusted/transcoded by the controller module 206, such as to make the video content in accordance with the estimated bandwidth associated with the network channel 106. In an embodiment, the controller module 206, in communication with the codec module 204, can be configured to transcode the video content using transcoding parameters, which can be in accordance with (or matches with the estimated bandwidth associated with the network channel used by the video client). Further, the various operations performed by the controller module 206 to transcode the video bit rate is described in conjunction with the FIG. 3.

In an embodiment, the communications module 208 described herein can be configured to transmit/receive the video content to the video client 102 over the network channel 106. Further, the communications module 208 can include capabilities to interact/communicate with various local and remote devices over the network channel 106.

FIG. 3 is a sequence diagram illustrating operations 300 performed by the system 100 as described in the FIG. 1, according to the embodiments disclosed herein. In an embodiment, at 302, the controller module 206 can be configured to receive a request from the video client 102. In an example, the video client 102 can provide the request to access a stored or live video content over the network channel 106. The communication module 208 can be configured to receive the request from the video client 102 and forward to the controller module 206 for further processing.

In an embodiment, at 304, the controller module 206 can be configured to accept the remote client request and retrieve the video content from the storage module 202. In an example, the storage module 202 can be configured to interact or communicate with one or more local or remote video source to retrieve the stored or live video content. In an embodiment, at 306, the storage module 202, in communication with the controller module 206 can be configured to provide the retrieved content to the codec module 204. In an example, the video content provided by the storage module 202 can be a raw video stream, an encoded, compressed, or encrypted video stream, or a decoded, decompressed, or decrypted video stream.

In an embodiment, at 308, the codec module 204 can be configured to encode/compress and/or decode/decompress the video content received from the storage module 202. In an example, the codec module 204 can be configured to read the video content packets and decode the video content into a plurality of frames. The coding parameters used by the codec module 204 to encode or decode the video content can be stored in cache memory of the server 104.

In an embodiment, at 310, the controller module 206 can be configured to estimate the bandwidth associated with the communication channel 106 used by the video client 102. In an example, the controller module 206 can be configured to estimate the bandwidth through detection of the current transmission of data over the network channel 106. In an example, the controller module 206 can be configured to use any bandwidth determination technique known in the art to estimate the bandwidth associated with the network channel 106.

In an embodiment, at 312, the controller module 206 can be configured to determine whether the estimated bandwidth reaches the bandwidth threshold. In an example, a bandwidth threshold can be predefined and stored by the controller module 206, such as to determine the need of changing the format of the video (such as changing the bit rate, frame rate, frame size, and/or compression standard). The controller module 206 can be configured to compare the estimated bandwidth associated with the network channel 106 against the bandwidth threshold, such as to provide optimal video content which is in accordance with the network channel 106 used by the video client 102.

In an embodiment, at 314, the controller module 206 can be configured to clear the coding parameters associated with plurality of frames. In an example, the codec module 202 stores the coding parameters associated with plurality of frames into the cache. The controller module 206 can be configured to clear the coding parameters associated with the plurality of frames in response to determining that the estimated bandwidth associated with the network channel 106 reaches the bandwidth threshold. Further, in an embodiment, the controller module 206 can use the plurality of frames to create the packets and send the packets over the communication network 106 associated with the video client 102.

In an embodiment, at 316, the controller module 206 can be configured to generate and reinitialize the new transcoding parameters. In an example, the controller module 206 can generate and reinitialize the transcoding parameters to transcode the plurality of frames in accordance with the estimated bandwidth associated with the network channel 106. In an embodiment, at 318, the controller module 206 provides the transcoding parameters to the codec module 202 to transcode the video content. In an example, the transcoding parameters provided by the controller module 206 can be configured to be in accordance with the estimated bandwidth associated with the network channel 106, such as to provide optimal video to the video client 102 associated with the network channel 106.

In an embodiment, at 320, unlike conventional systems, the codec module 202 can be configured to transcode the video (the same single video content) using the transcoding parameters. In an embodiment, the codec module 202 can be configured to transcode the video bit rate according to the estimated bandwidth associated with the network channel 106 used by the video client 102. For example, if the video client 102 is associated with a low-bandwidth network channel 106 then the video bit rate can be converted to low bit rate. In an embodiment, the codec module 202 can be configured to transcode the video frame rate in according to the estimated bandwidth associated with the network channel 106. For example, if a handheld device can only play video at a low frame rate (for example, 5 or 10 frames per second) then the codec module 202 can transcode the video needs to low frame rate. In an embodiment, the frame rate conversion can also reduce the bit rate. In an embodiment, the codec module 202 can be configured to transcode the video frame size according to the estimated bandwidth associated with the network channel 106. For example, if a handheld device can only display small size video then the codec module 202 can transcode the video frames to small frame size.

In an embodiment, at 322, the codec module 202 can be configured to create video packets using the plurality of transcoded frames and send the packets on the network channel 106. In an example, the codec module 202, in communication with the controller module 206, can be configured to use the plurality of the transcoded frames to create the video packets. Further, the codec module 202, in communication with the communication module 208, can be configured to transmit the video packets over the network channel 106 associated with the client 102.

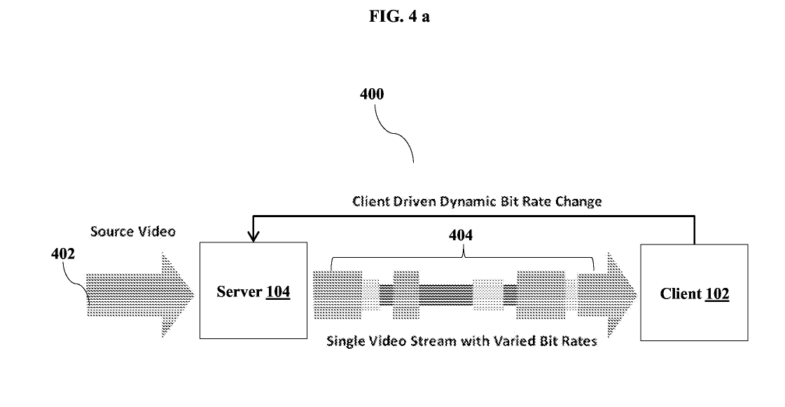

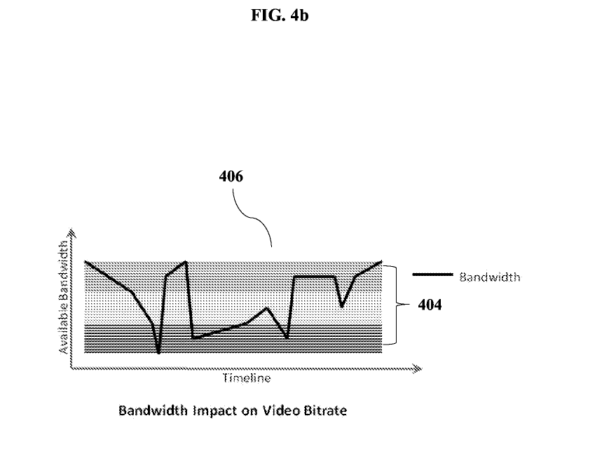

FIG. 4A illustrates generally an exemplary video stream 400 with varied bitrates, according to embodiments described herein. A single video stream 402 with variable bit rate 404 transferred from the server 104 to the video client 102 are shown in the FIG. 4A. The server 104 can be configured to dynamically change the bit stream 404 of the video stream 402 in accordance with the bandwidth associated with network channel 106 used by the client 102.

FIG. 4B illustrates generally an exemplary impact of bandwidth 406 on the video bitrates 402 as described in the FIG. 4A, according to embodiments described herein. As shown in the FIG. 4B, as the bandwidth associated with network channel 106 used by the client 102 decreases the sever 102 can be configured to transcode the video stream 402 to lower the bit rates and transmit the video over the network channel. Similarly, as the bandwidth associated with network channel 106 used by the client 102 increases the sever 102 can be configured to transcode the video stream 402 to higher the bit rates and transmit the video over the network channel.

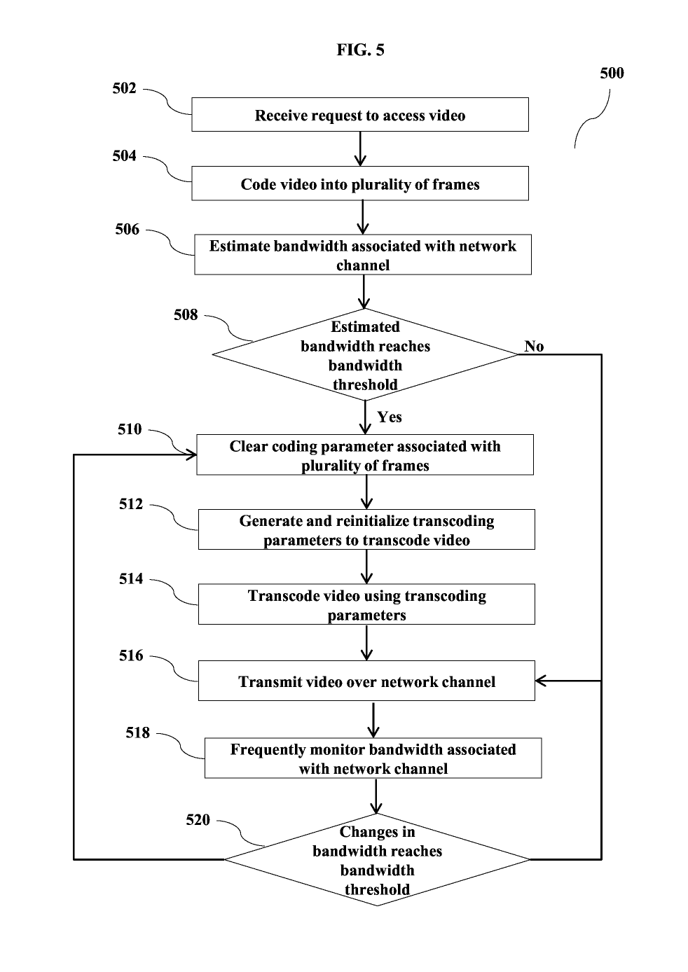

FIG. 5 is a flowchart illustrating a method 500 for transmitting optimal video over a network channel, according to the embodiments disclosed herein. In an embodiment, at step 502, the method 500 includes receiving a request to access a video over the network channel. In an example, the method 500 allow the video client 102 to provide the request to access a stored or live video content over the network channel 106. The method 500 allows the communication module 208 to receive the request from the video client 102 and forward to the controller module 206. Further, the method 500 allows the controller module 206 to accept the remote client request and retrieve the video content from the storage module 202. The storage module 202 can interact or communicate with one or more local or remote video source to retrieve the stored or live video content. In an example, the video content retrieved by the storage module 202 can be a raw video stream, an encoded, compressed, or encrypted video stream, or a decoded, decompressed, or decrypted video stream.

In an embodiment, at step 504, the method 500 includes coding the video content into a plurality of frames. In an example, the method 500 allows the codec module 204 to read the video content packets and decode the video content into the plurality of frames. The coding parameters used by the codec module 204 to encode or decode the video content can be stored in cache memory of the server 104.

In an embodiment, at step 506, the method 500 includes estimating the bandwidth associated with the network channel. In an example, the method 500 allows the controller module 206 to estimate the bandwidth through detection of the current transmission of data over the network channel 106. Further, the method 500 allows the controller module 206 to use any bandwidth determination technique known in the art to estimate the bandwidth associated with the network channel 106.

In an embodiment, at step 508, the method 500 includes whether the estimated bandwidth reaches a bandwidth threshold. In an example, the method 500 allows the controller module 206 predefine the controller module 206 to determine the need of changing the format of the video (such as changing the bit rate, frame rate, frame size, and/or compression standard). The method 500 allows the controller module 206 to compare the estimated bandwidth associated with the network channel 106, used by the video client 102, against the bandwidth threshold, such as to provide optimal video content which is in accordance with the network channel 106 used by the video client 102.

In an embodiment, at step 510, the method 500 includes clearing the coding parameter associated with the plurality of frames. In an example, the coding parameters are stored in the cache of the server 104. The method 500 allows the controller module 206 to clear the coding parameters associated with the plurality of frames in response to determining that the estimated bandwidth associated with the network channel 106 reaches the bandwidth threshold. Further, in an embodiment, the method 500 allows the controller module 206 to use the plurality of frames to create the packets and send the packets over the communication network 106 associated with the video client 102.

In an embodiment, at step 512, the method 500 includes generating and reinitializing transcoding parameters to transcode the video content. In an example, the method 500 allows the controller module 206 to generate and reinitialize the transcoding parameters to transcode the plurality of frames in accordance with the estimated bandwidth associated with the network channel 106. The transcoding parameters generated and reinitialized by the controller module 206 can be in accordance with the estimated bandwidth associated with the network channel 106. Further, the method 500 allows the controller module 206 to provide the transcoding parameters to the codec module 202 to transcode the video content, such as to provide optimal video to the video client 102 associated with the network channel 106.

In an embodiment, at step 514, the method 500 includes transcoding the video content (the same single video content) using the transcoding parameters. In an example, the method 500 allows the codec module 202 to transcode the video bit rate, video frame rate, video frame size, and the like, according to the estimated bandwidth associated with the network channel 106 used by the video client 102.

In an embodiment, at step 516, the method 500 includes transmitting the video over the network channel. The video (or the transcoded video) transmitted herein can be in accordance with the bandwidth associated with the network channel 106 used by the video client 102. In an example, the method 500 allows the codec module 202, in communication with the controller module 206, to use the plurality of the transcoded frames to create the video packets. Further, the method 500 allow the codec module 202, in communication with the communication module 208, to transmit the video packets over the network channel 106 associated with the video client 102.

In an embodiment, at step 518, the method 500 includes frequently monitoring bandwidth associated with the network channel. In an example, the method 500 allows the controller module 206 to frequently monitor the bandwidth associated with the network channel 106. The frequent monitoring of the bandwidth associated with the network channel 106 can allow the controller module 206 to provide seamless, optimal, smooth, reliable, uninterrupted, and enhanced video content to the video client 102.

In an embodiment, at step 520, the method 500 includes determining if any changes occurred in the bandwidth associated with the network channel 106 used but the video client 102. Any changes in the bandwidth can affect the performance, sensitivity, cost, and reliability of the server 104. In an embodiment, upon detecting any changes in the bandwidth associated with the network channel 106, the method 500 includes repeating the steps 510 through 520, such as to provide seamlessly smooth and uninterrupted video content to the video client 102 associate with the network channel 106.

The various actions, steps, blocks, or acts described with respect to the FIGS. 3 and 5 can be performed in sequential order, in random order, simultaneously, parallel, or a combination thereof. Further, in some embodiments, some of the steps, blocks, or acts can be omitted, skipped, modified, or added without departing from the scope of the embodiment.

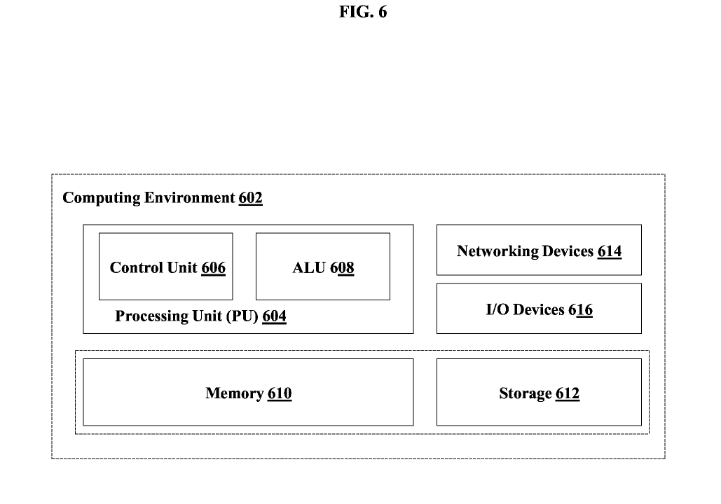

FIG. 6 illustrates a computing environment 602 implementing the method and systems as disclosed in the embodiments herein. As depicted the computing environment 602 comprises at least one processing unit 604 that is equipped with a control unit 606 and an Arithmetic Logic Unit (ALU) 608, a memory 610, a storage unit 612, plurality of networking devices 614 and a plurality Input output (I/O) devices 616. The processing unit 604 is responsible for processing the instructions of the algorithm. The processing unit 604 receives commands from the control unit 606 in order to perform its processing. Further, any logical and arithmetic operations involved in the execution of the instructions are computed with the help of the ALU 608.

The overall computing environment 602 can be composed of multiple homogeneous and/or heterogeneous cores, multiple CPUs of different kinds, special media and other accelerators. The processing unit 604 is responsible for processing the instructions of the algorithm. Further, the plurality of processing units 604 may be located on a single chip or over multiple chips.

The algorithm comprising of instructions and codes required for the implementation are stored in either the memory unit 610 or the storage 612 or both. At the time of execution, the instructions may be fetched from the corresponding memory 610 and/or storage 612, and executed by the processing unit 604.

In case of any hardware implementations various networking devices 614 or external I/O devices 616 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 5 include blocks, steps, operations, and acts, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for transmitting optimal video over a network channel, the method comprising:
coding a video into a plurality of frames;
estimating bandwidth associated with said network channel;
determining whether said estimated bandwidth associated with said network channel reaches a bandwidth threshold;
transcoding said video in response to determining that said estimated bandwidth associated with said network channel reaches said bandwidth threshold; and
transmitting said transcoded video over said network channel.

2. The method of claim 1, wherein said transcoded video is in accordance with said estimated bandwidth associated with said network channel.

3. The method of claim 1, wherein said method further comprises clearing at least one coding parameter associated with said plurality of frames.

4. The method of claim 3, wherein said at least one coding parameter is cleared in response to determining that said estimated bandwidth associated with said network channel reaches said bandwidth threshold.

5. The method of claim 1, wherein said method further comprises generating at least one transcoding parameter to transcode said video.

6. The method of claim 5, wherein said at least one transcoding parameter is in accordance with said estimated bandwidth associated with said network channel.

7. The method of claim 5, wherein said at least one transcoding parameter is generated in response to determining that said estimated bandwidth associated with said network channel reaches said bandwidth threshold.

8. The method of claim 1, wherein said method further comprises using said at least one transcoding parameter to transcode said plurality of frames.

9. The method of claim 8, wherein said method further comprises creating at least one packet using said plurality of transcoded frames.

10. The method of claim 8, wherein said method further comprises transmitting said at least one packet over said network channel.

11. The method of claim 1, wherein said method further comprises frequently monitoring said bandwidth associated with said network channel.

12. The method of claim 11, wherein said method further comprises transcoding said video based on said monitoring result.

13. A system for transmitting optimal video over a network channel, the system comprising a server configured to:
code a video into a plurality of frames;
estimate bandwidth associated with said network channel;
determine whether said estimated bandwidth associated with said network channel reaches a bandwidth threshold;
transcode said video in response to determining that said estimated bandwidth associated with said network channel reaches said bandwidth threshold; and
transmit said transcoded video over said network channel.

14. The system of claim 13, wherein said transcoded video is in accordance with said estimated bandwidth associated with said network channel.

15. The system of claim 13, wherein said server further configured to clear at least one coding parameter associated with said plurality of frames.

16. The system of claim 5, wherein said at least one coding parameter is cleared in response to determining that said estimated bandwidth associated with said network channel reaches said bandwidth threshold.

17. The system of claim 13, wherein said server further configured to generate at least one transcoding parameter to transcode said video.

18. The system of claim 17, wherein said at least one transcoding parameter is in accordance with said estimated bandwidth associated with said network channel.

19. The system of claim 17, wherein said at least one transcoding parameter is generated in response to determining that said estimated bandwidth associated with said network channel reaches said bandwidth threshold.

20. The system of claim 13, wherein said server further configured to use said at least one transcoding parameter to transcode said plurality of frames.

21. The system of claim 20, wherein said server further configured to create at least one packet using said plurality of transcoded frames.

22. The system of claim 20, wherein said server further configured to transmit said at least one packet over said network channel.

23. The system of claim 13, wherein said server further configured to frequently monitor said bandwidth associated with said network channel.

24. The system of claim 23, wherein said server further configured to transcode said video based on said monitoring result.

25. A computer program product transmitting optimal video over a network channel, the product comprising:
an integrated circuit comprising at least one processor; at least one memory having a computer program code within said circuit, wherein said at least one memory and said computer program code with said at least one processor cause said product to:
code a video into a plurality of frames,
estimate bandwidth associated with said network channel,
determine whether said estimated bandwidth associated with said network channel reaches a bandwidth threshold,
transcode said video in response to determining that said estimated bandwidth associated with said network channel reaches said bandwidth threshold, and
transmit said transcoded video over said network channel.
